(19) United States
(12) Patent Application Publication
(10) Pub. No.: US 2018/0294123 A1
(43) Pub. Date: Oct. 11, 2018

(54) ELECTRICAL SYSTEM AND ELECTRICAL SWITCHING APPARATUS THEREFOR

(71) Applicant: COOPER TECHNOLOGIES COMPANY, Houston, TX (US)

(72) Inventors: RICHARD JAMES SMITH, WAUKESHA, WI (US); MOHANESH MADHUKAR PATOLE, Maharashtra (IN); AMOL NIVRATIRAO JADHAV, Parbhani (IN); RANDAL VERNON MALLIET, Waukesha, WI (US); BRYAN JOSEPH LOEB, Menomonee Falls, WI (US); KURT LAWRENCE LINDSEY, Milwaukee, WI (US); ARTHUR THOMAS DAVIES, Waukesha, WI (US)

(73) Assignee: COOPER TECHNOLOGIES COMPANY, Houston, TX (US)

(21) Appl. No.: 15/484,366

(22) Filed: Apr. 11, 2017

(51) Int. Cl. H01H 71/12

(52) U.S. Cl. CPC H01H 71/12

(57) ABSTRACT

An electrical switching apparatus is for an electrical system. The electrical system has an enclosure and an electrical apparatus coupled to the enclosure. The electrical switching apparatus includes a pair of separable contacts electrically connected to the electrical apparatus, an operating handle for opening and closing the pair of separable contacts, and a support assembly having a cover and an elongated extension extending from proximate the cover to proximate the operating handle. The cover at least partially encloses the pair of separable contacts. The elongated extension is structured to be coupled to the enclosure.

### BACKGROUND

### Field

The disclosed concept relates to electrical systems including, for example, transformers. The disclosed concept further relates to electrical switching apparatus for electrical systems.

### Background Information

A transformer is a device that transfers electrical energy from a primary circuit to a secondary circuit by magnetic coupling. Typically, a transformer includes one or more windings wrapped around a core. An alternating voltage applied to one winding (a “primary winding”) creates a time-varying magnetic flux in the core, which induces a voltage in the other (“secondary”) winding(s). Varying the relative number of turns of the primary and secondary windings about the core determines the ratio of the input and output voltages of the transformer. For example, a transformer with a turn ratio of 2:1 (primary:secondary) has an input voltage that is two times greater than its output voltage. It is well known in the art to cool high-power transformers using a dielectric fluid, such as a highly-refined mineral oil. The dielectric fluid is stable at high temperatures and has excellent insulating properties for suppressing corona discharge and electric arcing in the transformer. Typically, the transformer includes a tank that is at least partially filled with the dielectric fluid. The dielectric fluid surrounds the transformer core and windings.

Over-current protection devices are widely used to prevent damage to the primary and secondary circuits of transformers. For example, many known distribution transformers are protected from fault currents by high voltage fuses provided on the primary windings. Typically, the fuses are submerged in the dielectric fluid. Over the years, the physical design of the transformers has evolved to efficiently utilize the location of the fuse in conjunction with industry standards. However, it is often desirable to utilize a suitable electrical switching and protecting apparatus, such as a circuit breaker, in place of the fuse. When changing from a fuse to a circuit breaker, it is desirable for the circuit breaker to utilize the same mounting location as the fuse. However, known transformer circuit breakers are configured such that they would undesirably require a larger transformer tank and an increased volume of dielectric fluid if they were substituted for a fuse.

There is, therefore, room for improvement in electrical systems and electrical switching apparatus therefor.

### SUMMARY

These needs and others are met by embodiments of the disclosed concept, which are directed to a novel electrical system and electrical switching apparatus therefor.

As one aspect of the disclosed concept, an electrical switching apparatus is provided for an electrical system. The electrical system has an enclosure and an electrical apparatus coupled to the enclosure. The electrical switching apparatus includes a pair of separable contacts electrically connected to the electrical apparatus, an operating handle for opening and closing the pair of separable contacts, and a support assembly having a cover and an elongated extension extending from proximate the cover to proximate the operating handle. The cover at least partially encloses the pair of separable contacts. The elongated extension is structured to be coupled to the enclosure.

As another aspect of the disclosed concept, an electrical system including the aforementioned electrical switching apparatus is provided.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a portion of an electrical system and electrical switching apparatus therefor, in accordance with a non-limiting embodiment of the disclosed concept;

FIG. 2 is an isometric view of a component for another electrical switching apparatus, in accordance with another non-limiting embodiment of the disclosed concept;

FIG. 3 is an isometric view of another electrical switching apparatus, in accordance with another non-limiting embodiment of the disclosed concept;

FIG. 4 is an isometric view of another electrical switching apparatus, in accordance with another non-limiting embodiment of the disclosed concept;

FIG. 5 is an isometric view of an elongated extension component for the electrical switching apparatus of FIG. 4;

FIGS. 6A and 6B are top plan and side elevation views, respectively, of a retaining component for the electrical switching apparatus of FIG. 4;

FIG. 7 is an isometric view of another electrical switching apparatus, shown with a portion of a transformer tank, in accordance with another non-limiting embodiment of the disclosed concept;

FIG. 8 is an isometric view of a cover portion for the electrical switching apparatus of FIG. 7;

FIGS. 9A and 9B are top plan and side elevation views, respectively, of a retaining component for the electrical switching apparatus of FIG. 7;

FIG. 10 is an isometric view of another electrical switching apparatus, shown with a portion of a transformer tank, in accordance with another non-limiting embodiment of the disclosed concept;

FIGS. 11 and 12 are different isometric views of another electrical switching apparatus, in accordance with another non-limiting embodiment of the disclosed concept;

FIG. 13 is a side elevation view of the electrical switching apparatus of FIGS. 11 and 12, shown with a portion of a transformer tank; and

FIG. 14 is an isometric view of a component for the electrical switching apparatus of FIG. 13.

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts.

As employed herein, the statement that two or more parts or components “engage” one another shall mean that the parts exert a force against one another either directly or through one or more intermediate parts or components.

As employed herein, the term “coupling member” refers to any suitable connecting or tightening mechanism expressly including, but not limited to, zip ties, wire ties, rivets, screws, bolts, the combination of bolts and nuts (e.g., without limitation, lock nuts), and washers and nuts.

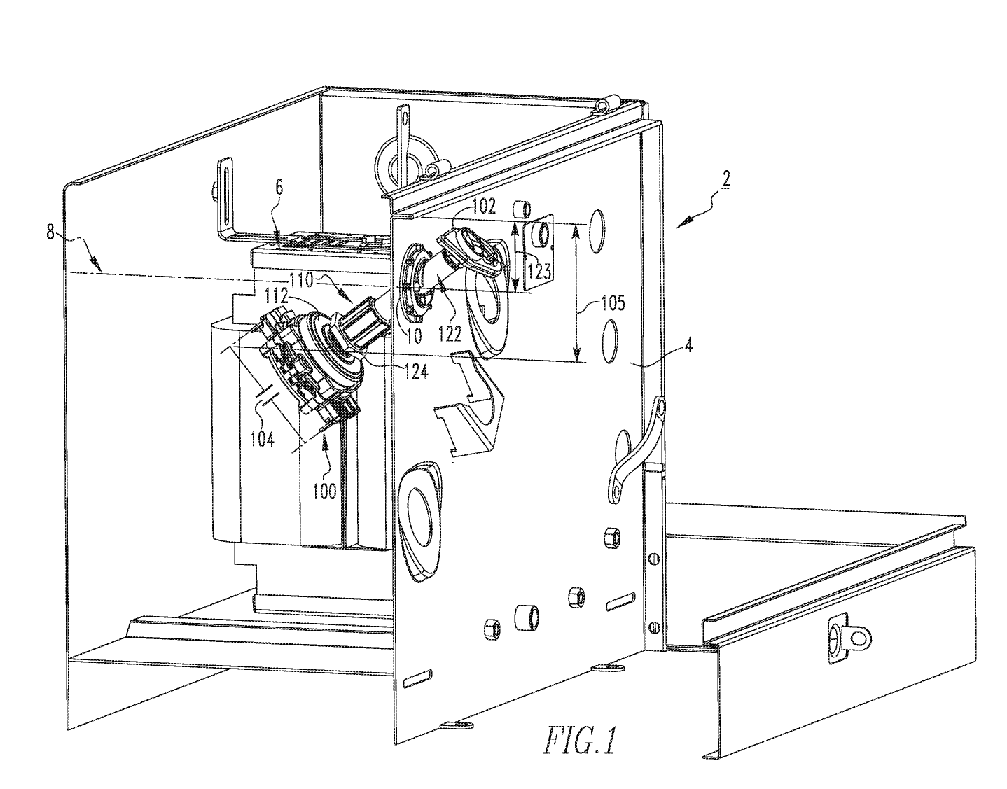

FIG. 1 shows a portion of an electrical system 2, in accordance with a non-limiting embodiment of the disclosed concept. The example electrical system 2 includes an enclosure (e.g., without limitation, transformer tank 4, partially shown), an electrical apparatus (e.g., without limitation, transformer 6), and a novel electrical switching apparatus (e.g., without limitation, circuit breaker 100). The transformer 6 is coupled to the transformer tank 4. The circuit breaker 100 has an operating handle 102, and a pair of separable contacts 104 (shown in simplified form) electrically connected to the transformer 6. The operating handle 102 is structured to open and close the pair of separable contacts 104. As will be discussed below, the circuit breaker 100 further has a support assembly 110 that includes a cover 112 and an elongated extension 122 extending from proximate the cover 112 to proximate the operating handle 102 in order to provide novel improvements to the electrical system 2.

Specifically, the electrical system 2 is advantageously able to use the circuit breaker 100 instead of a fuse device (not shown), without requiring substantial and/or any modification to the transformer tank 4 (i.e., without requiring a larger transformer tank) and without the electrical system 2 requiring an increase in dielectric fluid. The electrical system 2 achieves this benefit by virtue of the elongated extension 122 and the angle with which the elongated extension 122 extends through the transformer tank 4. Accordingly, the cover 112 at least partially encloses the separable contacts 104, and the elongated extension 122 functions to position the switching portion (i.e., the separable contacts 104) at a lower elevation in the transformer tank 4. This advantageously reduces the need for a larger transformer tank and/or an increase in oil to accommodate the circuit breaker 100 in place of a fuse device (not shown).

As shown, the electrical system 2 further has a predetermined quantity of dielectric fluid (e.g., without limitation, oil 8, shown in simplified form) structured to be contained by the transformer tank 4, and the elongated extension 122 extends through the transformer tank 4 at a junction 10 that is at or about a top surface of the oil 8. In order for the electrical system 2 to function properly, it is necessary that the transformer 6 and the switching portion of the circuit breaker 100 be submerged in the oil 8.

Prior art circuit breakers (not shown) are typically mounted directly to the wall of the transformer tank, or on top of the transformer core/coil and are connected to a winding (primary or secondary). Prior art circuit breakers must have clearance to the other winding and to other adjacent devices mounted on the wall. The space needed on the wall for such prior art circuit breakers and the clearances to other devices undesirably causes the transformer tank size (e.g., height, width, or depth) to be increased. Furthermore, it will be appreciated that prior art circuit breakers (not shown) generally extend straight through corresponding transformer tanks, thus requiring relatively large amounts of oil in order to be submerged. As shown, the elongated extension 122 of the instant disclosed concept extends through the transformer tank 4 such that the separable contacts 104 are at a lower elevation than the junction 10, with respect to a bottom of the transformer tank 4. That is, the acute angle with which the elongated extension 122 passes through the transformer tank 4 advantageously allows the separable contacts 104 to be positioned at a relatively low elevation in the transformer tank 4, thereby minimizing the amount of oil 8 required to submerge the separable contacts 104 and substantially reducing and/or eliminating the need to provide a larger transformer tank.

In the example of FIG. 1, the tubular portion of the elongated extension 122 is separately threadably coupled to the cover 112, and the support assembly 110 further includes a coupling member (e.g., without limitation, a jam nut 124) threadably coupled to the cover 112 that functions to minimize any movement of the circuit breaker 100 during wire attachment and in operation. However, it will be appreciated that any suitable alternative attachment mechanism may be employed with a support assembly, without departing from the scope of the disclosed concept.

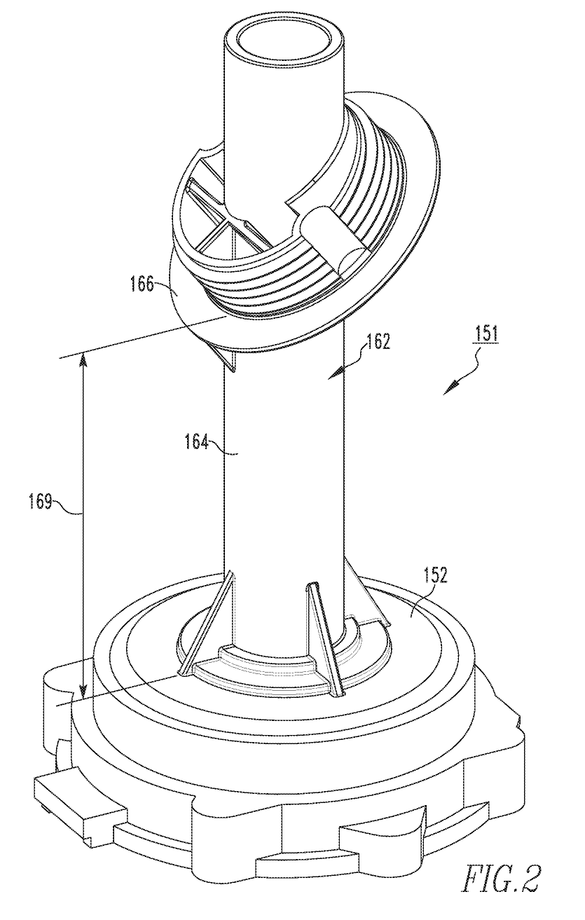

For example and without limitation, FIG. 2 shows a support assembly component 151, in accordance with another non-limiting embodiment of the disclosed concept, and in which the support assembly component 151 may be employed in the electrical system 2 of FIG. 1 in place of the support assembly 110. The support assembly component 151 functions similar to the support assembly 110 of the example of FIG. 1, and includes a cover portion 152 and an elongated extension portion 162 extending from the cover portion 152. As seen, the elongated extension portion 162 includes a tubular portion 164 and a flange portion 166 extending outwardly from the tubular portion 164. The flange portion 166 is structured to be positioned against (i.e., be generally flush with respect to) and be coupled to an interior of the transformer tank 4 (FIG. 1) in order to properly align a corresponding circuit breaker at a relatively low elevation in the transformer tank 4. It will be appreciated that the elongated extension 122 of FIG. 1 likewise includes a tubular portion and an annular-shaped flange portion (not shown in FIG. 1) extending outwardly from the tubular portion and functioning substantially the same as the flange portion 166. That is, the elongated extension 122 is likewise coupled to the transformer tank 4, and the flange portion (not shown) of the elongated extension 122 is positioned against an interior of the transformer tank 4.

However, different from the cover 112 (FIG. 1) and the elongated extension 122 (FIG. 1), the cover portion 152 and the elongated extension portion 162 are molded as one single unitary component made from a single piece of material. As such, assembly of a corresponding circuit breaker employing the support assembly component 151 is advantageously simplified in that no separate attachment steps are required to attach the cover portion 152 to the elongated extension portion 162. Continuing to refer to FIG. 2, the elongated extension portion 162 has a junction portion (i.e., flange portion 166) structured to engage the transformer tank 4 (FIG. 1), and spaced a distance 169 from the cover portion 152 of at least 2.0 inches. The relatively long distance (e.g., as compared with prior art circuit breakers, not shown) advantageously allows for relatively low positioning within the transformer tank 4, as will be discussed below.

Referring again to FIG. 1, the elongated extension 122 passes through the transformer tank 4 at a first depth 123 with respect to a top of the transformer tank 4. The separable contacts 104 are located at second depth 105 with respect to the top of the transformer tank 4. The difference between the first depth 123 and the second depth 105 is preferably greater than 2 inches, and more preferably greater than 2.5 inches. It will be appreciated that when the support assembly component 151 (FIG. 2) is employed in the electrical system 2 of FIG. 1 in place of the support assembly 110 (FIG. 1), the separable contacts 104 will likewise be positioned at a depth greater than 2.0 inches, and more preferably greater than 2.5 inches, with respect to a depth at which the elongated extension portion 162 passes through the transformer tank 4. Accordingly, the separable contacts 104 are advantageously able to be positioned relatively low within the transformer tank 4.

Similarly structured prior art circuit breakers (not shown), by way of contrast, do not have elongated extensions to allow for such positions. For example, some prior art circuit breakers (not shown) are mounted relatively high on top of a transformer core/coil. Others (not shown) are mounted via linkage assemblies to an enclosure wall and do not allow for low positioning within a tank. Furthermore, other prior art circuit breakers (not shown) have covers with short protruding portions that have lengths substantially less than the elongated extensions 122, 162, and are thus not able to be positioned at lower elevations in transformer tanks.

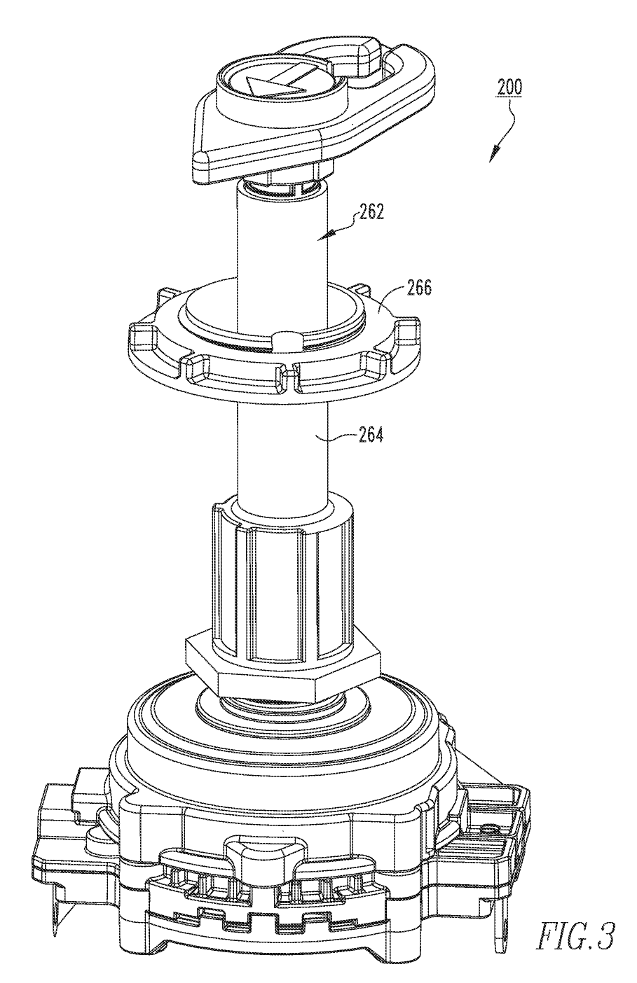

FIG. 3 shows another electrical switching apparatus (e.g., without limitation, circuit breaker 200), in accordance with another non-limiting embodiment of the disclosed concept. The example circuit breaker 200 is structured substantially the same as the circuit breaker 100 (FIG. 1), and as such provides similar advantages in terms of positioning within a transformer tank. However, the circuit breaker 200 includes an elongated extension component 262 that has a tubular portion 264 and a flange portion 266 extending from and being located generally perpendicular to the tubular portion 264. In other embodiments, it is contemplated that flange portions are located between 20 degrees and 90 degrees with respect to tubular portions. Accordingly, the circuit breaker 200 is advantageously able to be mounted to a cover (i.e., a top panel) of a transformer tank and still be positioned at a relatively low depth in the transformer tank. This is achievable via a suitable connection between the flange portion 266 and the cover of the transformer tank.

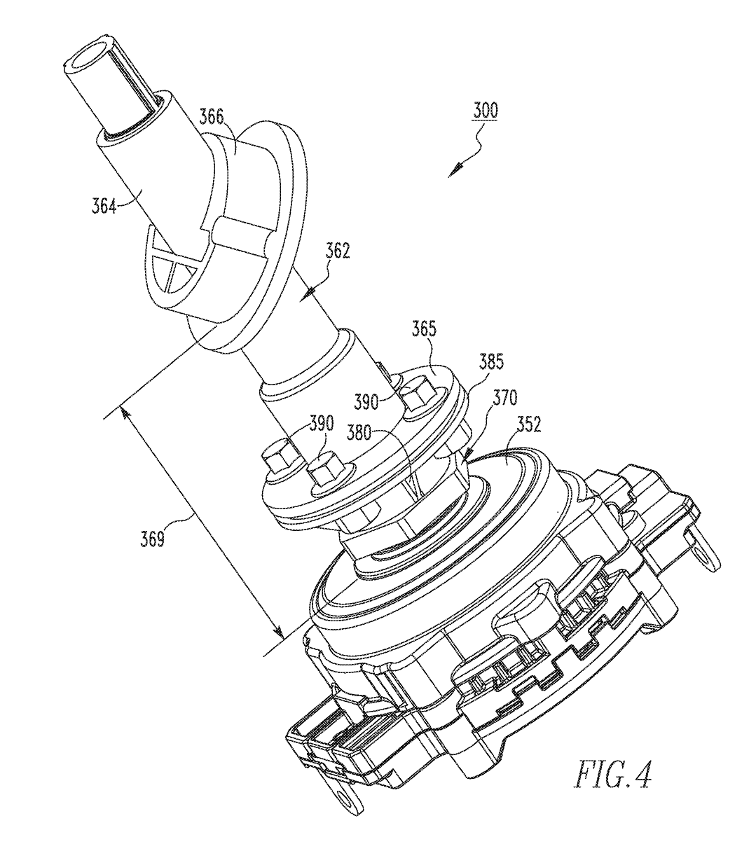

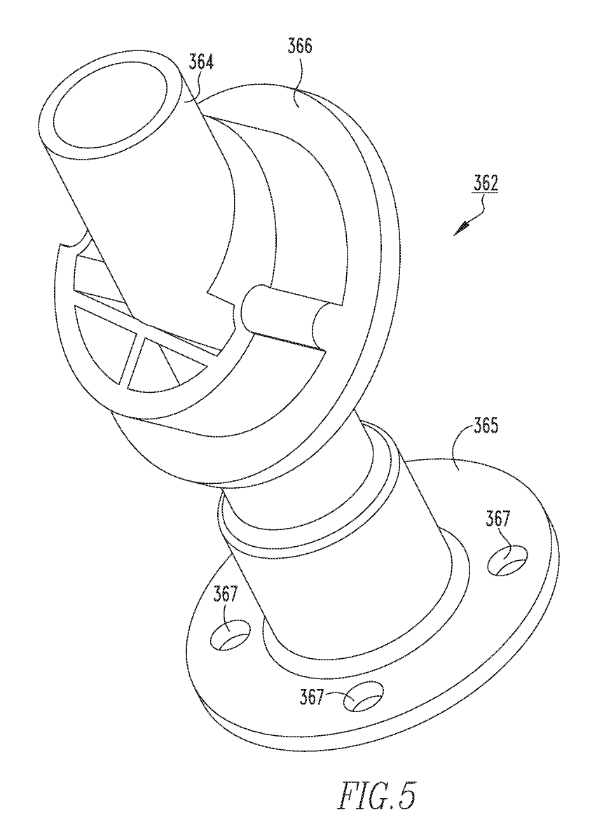

FIG. 4 shows another electrical switching apparatus (e.g., without limitation, circuit breaker 300), in accordance with another non-limiting embodiment of the disclosed concept. The example circuit breaker 300 is structured substantially the same as the circuit breaker 100 (FIG. 1), and as such provides similar advantages in terms of positioning within a transformer tank. More specifically, the support assembly of the circuit breaker 300 includes an elongated extension component 362 (also shown in FIG. 5). The elongated extension component 362 has a junction portion (i.e., a flange portion 366) structured to engage the transformer tank 4 (FIG. 1), and spaced a distance 369 from a cover portion 352 of the circuit breaker 300 of at least 2.0 inches.

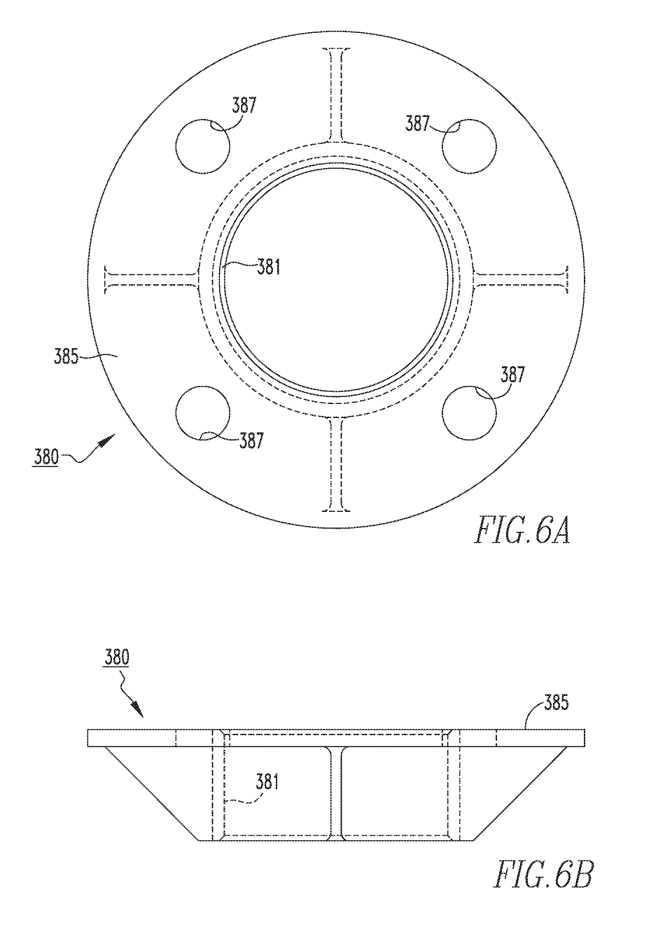

A retaining component 380 is coupled to the cover portion 352. As shown in FIG. 5, the elongated extension component 362 includes a tubular portion 364, the flange portion 366 extending outwardly from the tubular portion 364, and a generally planar coupling portion 365 extending outwardly from and being located perpendicular to the tubular portion 364. The coupling portion 365 has a plurality of thru holes 367. As shown in FIGS. 6A and 6B, the retaining component 380 has a threaded interior portion 381 defining a thru hole, and a generally planar coupling portion 385 extending from and being located perpendicular to the threaded portion 381. The coupling portion 385 has a plurality of thru holes 387 (FIG. 6A).

Referring again to FIG. 4, it will be appreciated that the threaded portion 381 (FIGS. 6A and 6B) of the retaining component 380 is threadably coupled to a cover portion 352 of the circuit breaker 300. It will also be appreciated that the planar portions 365, 385 are each generally flush with each other, and that the thru holes 367 (FIG. 5), 387 (FIG. 6A) are aligned with each other. As shown in FIG. 4, the support assembly of the circuit breaker 300 further includes a number of coupling members 390 each extending through a corresponding one of the thru holes 367 (FIG. 5) and through a corresponding one of the thru holes 387 (FIG. 6A) in order to couple the elongated extension component 362 to the retaining component 380 (i.e., and thus the cover portion 352). The support assembly further includes a coupling member (e.g., without limitation, a jam nut 370) threadably coupled to the cover portion 352 that functions to minimize any movement of the circuit breaker 300 during wire attachment and in operation.

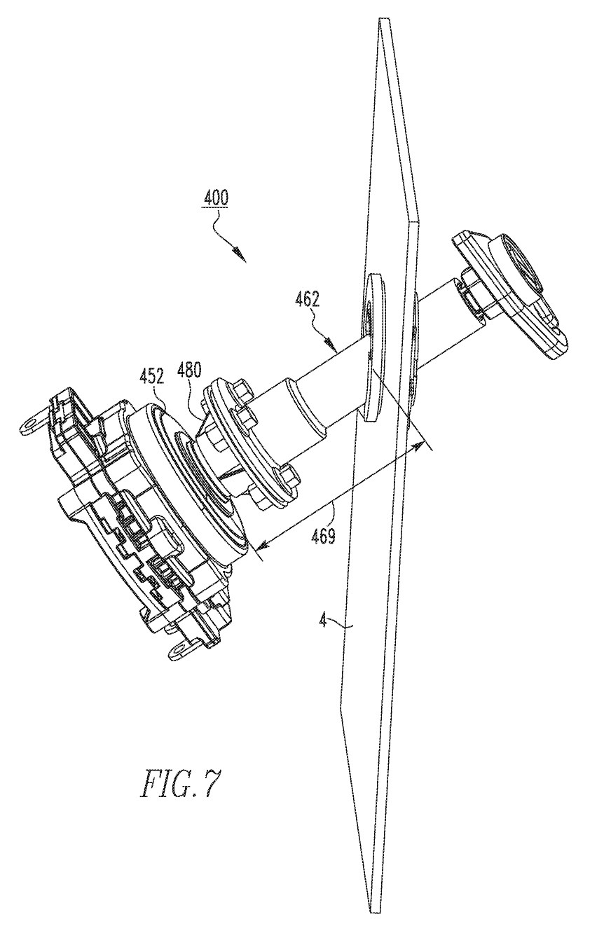

FIG. 7 shows another electrical switching apparatus (e.g., without limitation, circuit breaker 400), in accordance with another non-limiting embodiment of the disclosed concept. The example circuit breaker 400 is structured substantially the same as the circuit breaker 100 (FIG. 1), and as such provides similar advantages in terms of positioning within a transformer tank (see, for example, an example portion of the transformer tank 4, shown in FIG. 7). More specifically, the support assembly of the circuit breaker 400 includes a cover portion 452, an elongated extension component 462, and a retaining component 480 coupled to each of the cover portion 452 and the elongated extension component 462. The elongated extension component 462 has a junction portion (i.e., a flange portion) structured to engage the transformer tank 4, and spaced a distance 469 from a cover portion 452 of the circuit breaker 400 of at least 2.0 inches.

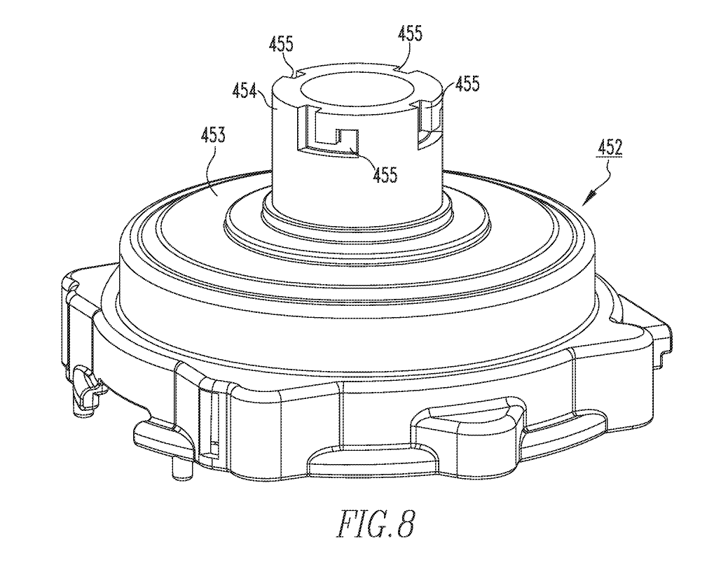

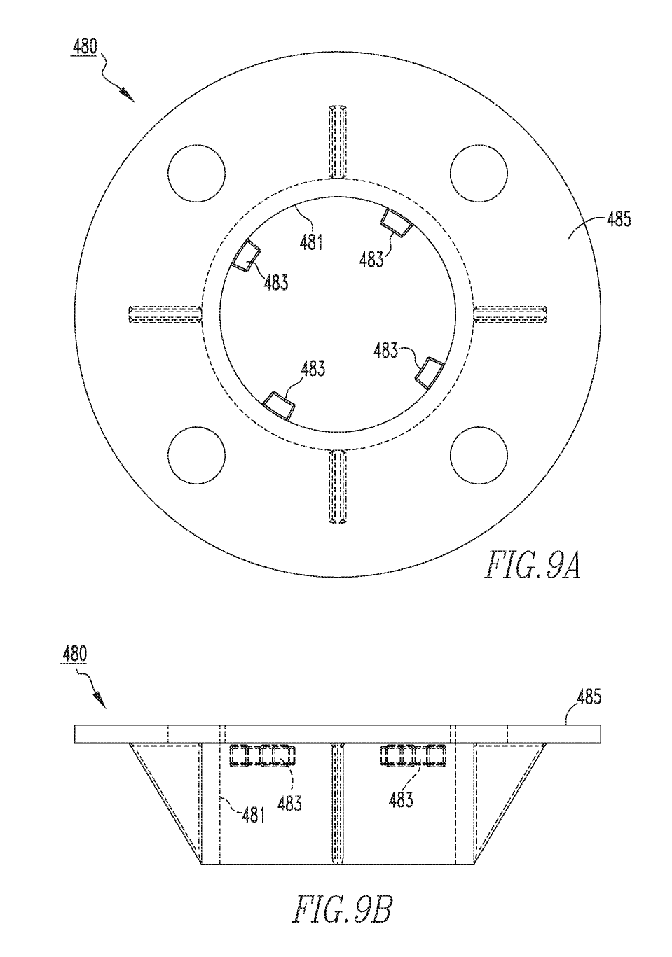

FIG. 8 shows the cover portion 452. As shown, the cover portion 452 includes a base portion 453 and a coupling portion 454 extending from and being located perpendicular to the base portion 453. The coupling portion 454 has a number of grooved portions 455. FIGS. 9A and 9B show the retaining component 480. As shown, the retaining component 480 has a first annular-shaped coupling portion 481, a number of protrusions 483 extending radially inwardly from the coupling portion 481, and a second coupling portion 485. It will be appreciated that each of the protrusions 483 is coupled to a corresponding one of the grooved portions 455 by a snap-action mechanism in order for the retaining component 480 to be securely coupled to the coupling portion 454 of the cover portion 452. Furthermore, the coupling portion 485 is coupled to the elongated extension component 462 in substantially the same manner by which the coupling portions 365, 385 (FIG. 4) are coupled together (i.e., via suitable coupling members extending through thru holes).

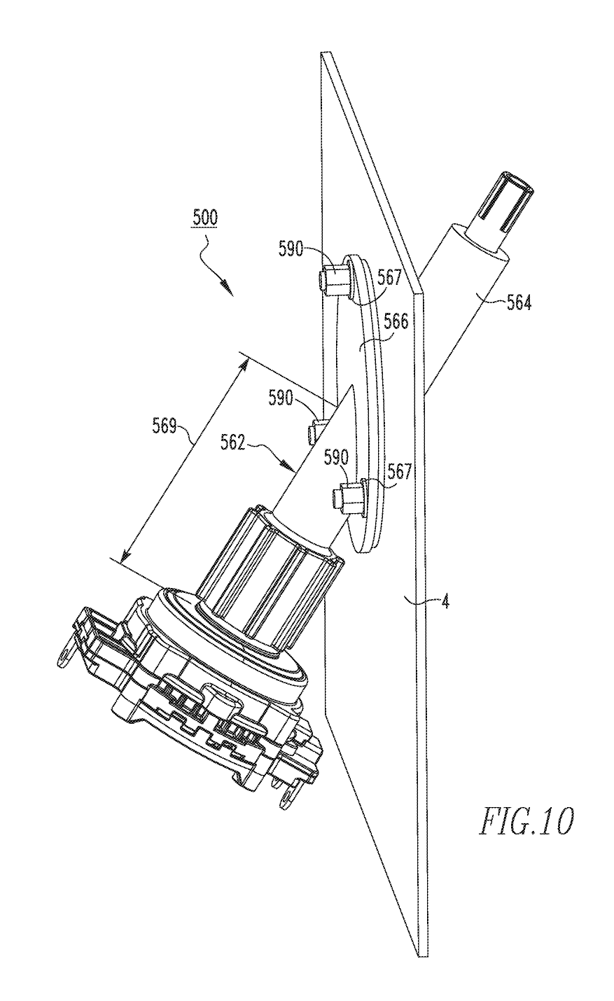

FIG. 10 shows another electrical switching apparatus (e.g., without limitation, circuit breaker 500), in accordance with another non-limiting embodiment of the disclosed concept. The example circuit breaker 500 is structured substantially the same as the circuit breaker 100 (FIG. 1), and as such provides similar advantages in terms of positioning within a transformer tank. More specifically, the circuit breaker 500 includes an elongated extension component 562, which includes a tubular portion 564 and a flange portion 566 extending outwardly from the tubular portion 564. The elongated extension component 562 has a junction portion (i.e., flange portion 566) structured to engage the transformer tank 4, and spaced a distance 569 from a cover portion of the circuit breaker 500 of at least 2.0 inches.

The flange portion 566 has a number of thru holes 567. An example portion of the transformer tank 4 is shown. The flange portion 566 advantageously allows the circuit breaker 500 to be coupled to the transformer tank 4. More specifically, the support assembly of the circuit breaker 500 includes a number of example coupling members 590 extending through the thru holes 567 in order to couple the flange portion 566 to the transformer tank 4. By employing with the flange portion 566 the thru holes 567, the tubular portion 564 is advantageously able to be located at a relatively steep angle with respect to the wall of the transformer tank 4, thereby allowing for separable contacts (not shown) of the circuit breaker 500 to be positioned at an even greater depth within the transformer tank 4.

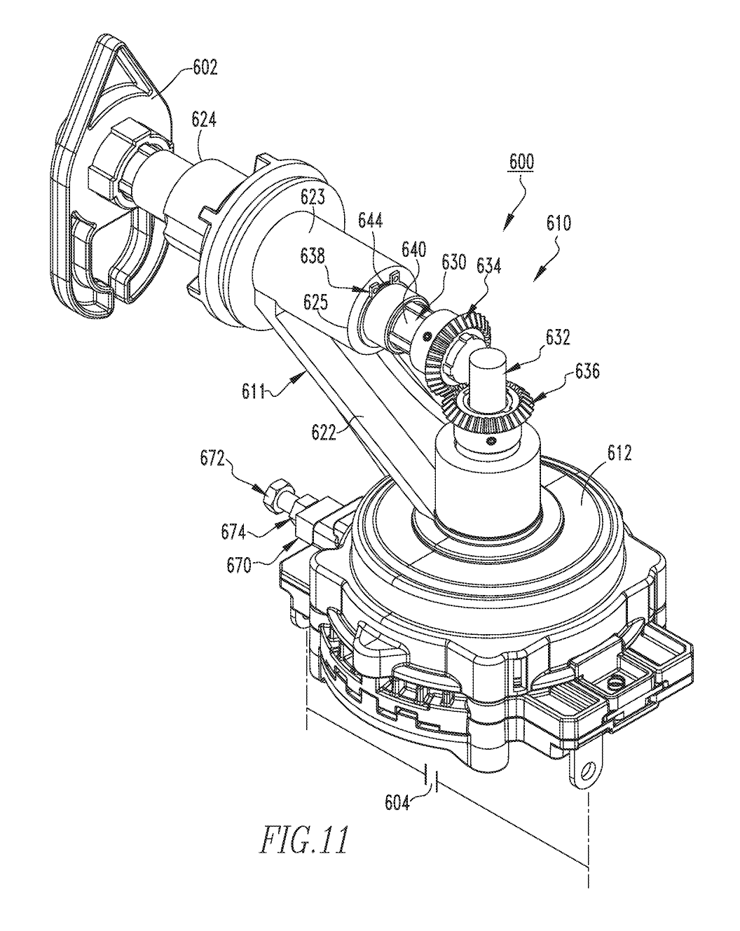

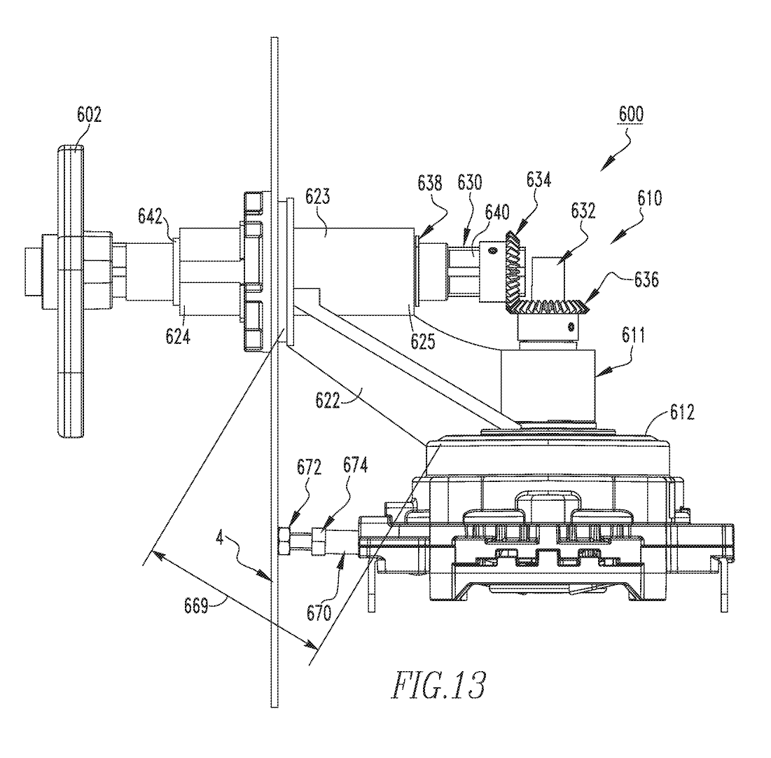

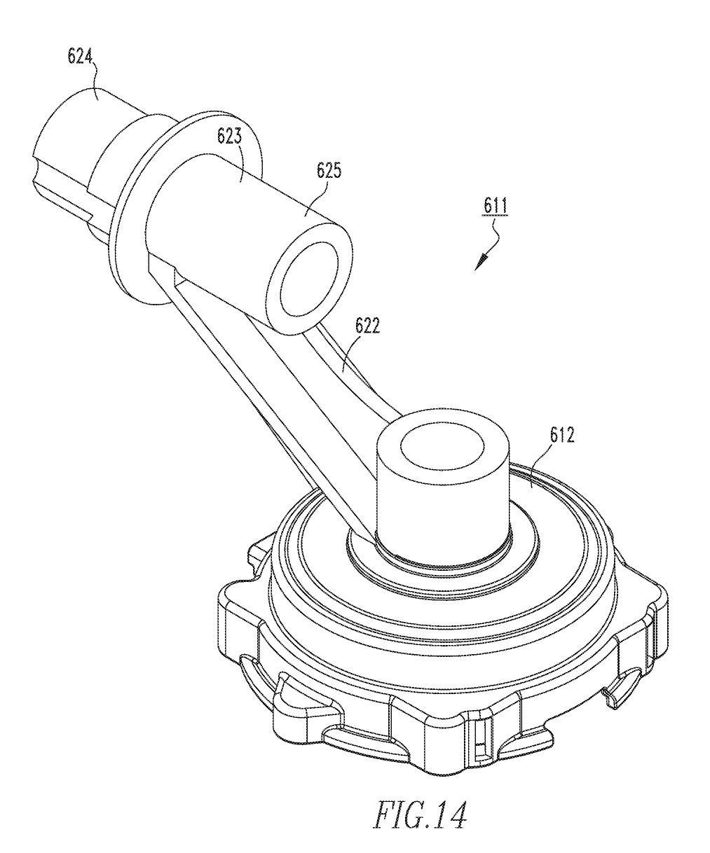

FIGS. 11-13 show different views of another electrical switching apparatus (e.g., without limitation, circuit breaker 600), in accordance with another non-limiting embodiment of the disclosed concept. FIG. 14 shows an isometric view of a support assembly component 611 for the circuit breaker 600 (FIGS. 11-13). The support assembly component 611 is preferably a single unitary component made from a single piece of material, and has a cover portion 612 and an elongated extension portion 622 extending outwardly from the cover portion 612. The elongated extension portion 622 has a cylindrical-shaped end portion 623 located opposite the cover portion 612. The end portion 623 has opposing distal end portions 624, 625. When installed in the electrical system 2 in place of the circuit breaker 100, the end portion 623 of the circuit breaker 600 is coupled to the transformer tank 4. The circuit breaker 600 provides similar advantages in terms of positioning within the transformer tank 4 as the circuit breakers 100, 200, 300, 400, 500, discussed above. More specifically, and as shown in FIG. 13, the elongated extension portion 622 has a junction portion (i.e., cylindrical-shaped end portion 623) structured to engage the transformer tank 4, and spaced a distance 669 from the cover portion 612 of at least 2.0 inches.

Referring again to FIGS. 11-13, the circuit breaker 600 includes an operating handle 602 and a support assembly 610. The support assembly 610 includes the support assembly component 611, a first shaft member 630, a second shaft member 632, a first bevel gear 634, a second bevel gear 636, a retaining clip 638, a casing member 670 coupled to the cover portion 612, and a number of coupling members 672, 674. The first shaft member 630 extends through the end portion 623 and is coupled to the operating handle 602 and the first bevel gear 634. The second shaft member 632 extends through the cover portion 612 and is coupled to the second bevel gear 636. The bevel gears 634, 636 engage and cooperate with one another. The circuit breaker 600 further includes a pair of separable contacts 604 (shown in simplified form in FIG. 11) substantially enclosed by the cover portion 612 and the casing member 670. The first and second shaft members 630, 632 and the first and second bevel gears 634, 636 cooperate with one another in order to open and close the pair of separable contacts 604.

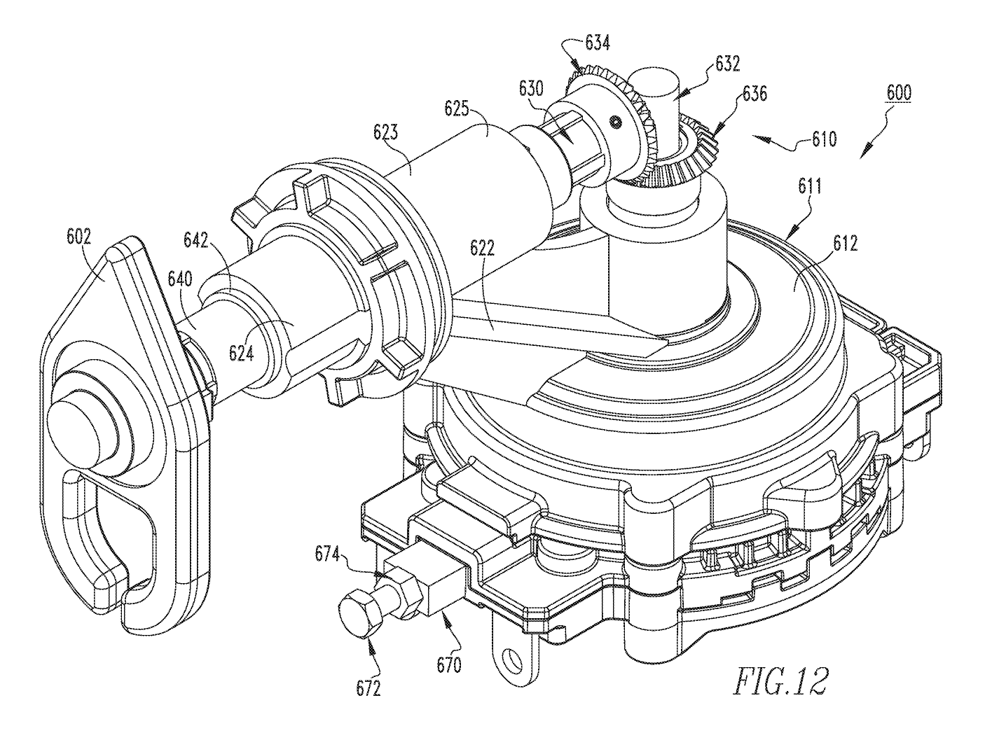

The first shaft member 630 is maintained in the end portion 623 in part by virtue of its engagement with the retaining clip 638. Specifically, the first shaft member 630 includes a body portion 640 having a grooved region 644, and the retaining clip 638 is disposed in the grooved region 644. Thus, the grooved region 644 of the first shaft member 630 is advantageously located proximate the second end portion 625. As seen in FIGS. 12-13, the first shaft member 630 further has a protrusion 642 extending outwardly from the body portion 640. The protrusion 642 engages and is located proximate the end portion 624. Accordingly, during assembly the first shaft member 630 is inserted through the end portion 623 until the protrusion 642 engages the end portion 624. Subsequently, the retaining clip 638 is placed in the grooved region 644, thus maintaining the first shaft member 630 on the end portion 623.

The circuit breaker 600 further has a mechanism to provide support and stability when installed in the electrical system 2 (FIG. 1) in place of the circuit breaker 100 (FIG. 1). Specifically, as seen in FIG. 13, the coupling member 672 engages a portion of the transformer tank 4, and is structured to extend through the coupling member 674 and into the casing member 670. As such, the coupling member 672 exerts a force on the transformer tank 4, and the corresponding opposing normal force by the transformer tank 4 on the coupling member 672 functions to support the circuit breaker 600 in the transformer tank 4. It will, however, be appreciated that other suitable alternative mechanisms may be employed in order to perform the desired function of providing support and stability. For example and without limitation, the coupling member 674 could be eliminated and the coupling member 672 could be replaced with a plastic arm that slides into the casing member 670 and snaps into place.

As stated above, the first and second shaft members 630, 632 and the first and second bevel gears 634, 636 cooperate with one another in order to open and close the pair of separable contacts 604 (FIG. 11). More specifically, opening of the separable contacts 604 (FIG. 11) causes the second shaft member 632 and the second bevel gear 636 to rotate. The second bevel gear 636 in turn drives (i.e., engages and causes to rotate) the first bevel gear 634, and in turn the first shaft member 630. In order to close the separable contacts 604 (FIG. 11), an operator can rotate the operating handle 602, which causes the first shaft member 630 and the first bevel gear 634 to rotate, thereby driving the second bevel gear 636 and the second shaft member 632 and closing the separable contacts 604 (FIG. 11).

Continuing to refer to FIGS. 11-13, the first shaft member 630 is located generally perpendicular with respect to the second shaft member 632. This allows the circuit breaker 600 to provide the same advantages as the circuit breaker 100 (FIG. 1) when installed in the electrical system 2 (FIG. 1) in place of the circuit breaker 100 (FIG. 1). Specifically, as seen in FIG. 13, the cover portion 612 is located at a lower elevation in the transformer tank 4 than the end portion 623. Accordingly, a top surface of the oil (see the top surface of the oil 8 in FIG. 1) can likewise be at a relatively low elevation in the transformer tank 4, thereby reducing the cost of the electrical system 2 (FIG. 1), and further allowing the transformer tank 4 to be employed without substantial and/or any modification. Continuing to refer to FIG. 13, the first shaft member 630 is located generally perpendicular with respect to the transformer tank 4. It will, however, be appreciated that the first shaft member 630 may be located at any suitable alternative angle with respect to the transformer tank (e.g., without limitation, greater than 90 degrees, similar to the elongated extension 122 of FIG. 1), provided the separable contacts 604 (FIG. 11) are positioned at a relatively low depth within the transformer tank 4.

Although the disclosed concept has been described herein in association with the transformer tank 4, it will be appreciated that the circuit breakers 100, 200, 300, 400, 500, 600 and support assemblies 110, 151, 610 may be employed in any suitable alternative electrical system (not shown) with or without a transformer, without departing from the scope of the disclosed concept. It will also be appreciated that while the example circuit breaker 100 in FIG. 1 is coupled to a front panel portion of the transformer tank 4, the circuit breaker 100, or a similar suitable alternative circuit breaker (i.e., the circuit breakers 200, 300, 400, 500, 600) may be coupled to any panel of the transformer tank 4, without departing from the scope of the disclosed concept. Finally, it will further be appreciated that the elongated extensions 122, 262 (FIG. 1 and FIG. 3, respectively), like the elongated extensions 162, 362, 462, 562, 622, have junction portions spaced a distance of at least 2.0 inches from corresponding covers 112 (i.e., and the cover of electrical switching apparatus 200, shown but not indicated).

Accordingly, it will be appreciated that the disclosed concept provides for an improved electrical system 2 and electrical switching apparatus 100, 200, 300, 400, 500, 600 therefor, in which the electrical switching apparatus 100, 200, 300, 400, 500, 600 can advantageously be employed in the electrical system 2 in place of a fuse device (not shown) without requiring substantial and/or any modification of a corresponding transformer tank 4 or an increase in an amount of oil 8.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An electrical switching apparatus for an electrical system, said electrical system comprising an enclosure and an electrical apparatus coupled to said enclosure, said electrical switching apparatus comprising:
a pair of separable contacts electrically connected to said electrical apparatus;
an operating handle for opening and closing said pair of separable contacts; and
a support assembly comprising a cover and an elongated extension extending from proximate said cover to proximate said operating handle, said cover at least partially enclosing said pair of separable contacts, said elongated extension being structured to be coupled to said enclosure.

2. The electrical switching apparatus of claim 1 wherein said elongated extension has a junction portion structured to engage said enclosure; and wherein the distance from said junction portion to said cover is at least 2.0 inches.

3. The electrical switching apparatus of claim 1 wherein said cover and said elongated extension are a unitary component made from a single piece of material.

4. The electrical switching apparatus of claim 1 wherein said elongated extension comprises a tubular portion and a flange portion extending outwardly from said tubular portion; and wherein said flange portion is structured to be coupled to said enclosure.

5. The electrical switching apparatus of claim 4 wherein said flange portion is disposed between 20 degrees and 90 degrees with respect to said tubular portion.

6. The electrical switching apparatus of claim 4 wherein the flange portion has a number of thru holes; and wherein said support assembly further comprises a number of coupling members each extending through a corresponding one of the thru holes and said enclosure in order to couple the flange portion to said enclosure.

7. The electrical switching apparatus of claim 1 wherein said elongated extension is separately coupled to said cover.

8. The electrical switching apparatus of claim 7 wherein said support assembly further comprises a retaining component coupled to said cover; wherein said retaining component has a coupling portion having a plurality of thru holes; wherein said elongated extension has a coupling portion having a plurality of thru holes each aligned with a corresponding one of the thru holes of said retaining component; and wherein said support assembly further comprises a number of other coupling members each extending through a corresponding one of the thru holes of said retaining component and a corresponding one of the thru holes of said elongated extension.

9. The electrical switching apparatus of claim 8 wherein the coupling portion of said retaining component is generally flush with the coupling portion of said elongated extension; and wherein said retaining component is threadably coupled to said cover.

10. The electrical switching apparatus of claim 7 wherein said cover comprises a base portion and a coupling portion extending from said base portion; wherein the coupling portion of said cover has a number of grooved portions; wherein said support assembly further comprises a retaining component coupled to said cover; wherein said retaining component has a second coupling portion and a number of protrusions extending radially inwardly from the second coupling portion; and wherein each of said protrusions is coupled to a corresponding one of the grooved portions by a snap-action mechanism.

11. The electrical switching apparatus of claim 1 wherein said support assembly further comprises a first shaft member and a second shaft member cooperating with said first shaft member in order to open and close said pair of separable contacts; wherein said first shaft member extends through said elongated extension; and wherein said second shaft member extends through said cover.

12. The electrical switching apparatus of claim 11 wherein said support assembly further comprises a first bevel gear and a second bevel gear; wherein said first shaft member is coupled to said operating handle and said first bevel gear; wherein said second shaft member is coupled to said second bevel gear; and wherein said first bevel gear and said second bevel gear cooperate with one another in order to open and close said pair of separable contacts.

13. The electrical switching apparatus of claim 11 wherein said support assembly further comprises a casing member, a first coupling member, and a second coupling member; wherein said casing member is coupled to said cover in order to substantially enclose said pair of separable contacts; wherein said first coupling member extends through said second coupling member and into said casing member; and wherein said first coupling member is structured to engage said enclosure in order to support said electrical switching apparatus on said enclosure.

14. The electrical switching apparatus of claim 1 wherein said electrical switching apparatus is a circuit breaker.

15. An electrical system comprising:
an enclosure; and
an electrical apparatus coupled to said enclosure; and
an electrical switching apparatus comprising:
a pair of separable contacts electrically connected to said electrical apparatus,
an operating handle for opening and closing said pair of separable contacts, and
a support assembly comprising a cover and an elongated extension extending from proximate said cover to proximate said operating handle, said cover at least partially enclosing said pair of separable contacts, said elongated extension being coupled to said enclosure.

16. The electrical system of claim 15 wherein said elongated extension passes through said enclosure at a first depth with respect to a top of said enclosure; wherein said pair of separable contacts are disposed at a second depth with respect to the top of said enclosure; and wherein the difference between the first depth and the second depth is greater than two inches.

17. The electrical system of claim 15 wherein said support assembly further comprises a first shaft member and a second shaft member cooperating with said first shaft member in order to open and close said pair of separable contacts; wherein said first shaft member extends through said elongated extension; and wherein said second shaft member extends through said cover.

18. The electrical system of claim 17 wherein said support assembly further comprises a first bevel gear and a second bevel gear; wherein said first shaft member is coupled to said operating handle and said first bevel gear; wherein said second shaft member is coupled to said second bevel gear; and wherein said first bevel gear and said second bevel gear cooperate with one another in order to open and close said pair of separable contacts.

19. The electrical system of claim 15 wherein said support assembly further comprises a casing member, a first coupling member, and a second coupling member; wherein said casing member is coupled to said cover in order to substantially enclose said pair of separable contacts; wherein said first coupling member extends through said second coupling member and into said casing member; and wherein said first coupling member engages said enclosure in order to support said electrical switching apparatus on said enclosure.

20. The electrical system of claim 15 further comprising a predetermined quantity of dielectric fluid contained by said enclosure; wherein said elongated extension extends through said enclosure at a junction; wherein said predetermined quantity of dielectric fluid has a top surface disposed at or about the junction; wherein said electrical apparatus is a transformer; and wherein said electrical switching apparatus is a circuit breaker.
